(19) United States
(12) Patent Application Publication
(10) Pub. No.: US 2015/0233768 A1
(43) Pub. Date: Aug. 20, 2015

(54) THERMAL DECOUPLING OF THE FIXATION OF A HIGH TEMPERATURE SENSOR IN A RECEIVING ELEMENT

(71) Applicant: TESONA GMBH & CO.KG, Hörselberg-Hainich (DE)

(72) Inventor: Heiko Lantzsch, Eisenach (DE)

(21) Appl. No.: 14/428,899

(22) PCT Filed: Sep. 16, 2013
(86) PCT No.: PCT/EP2013/069157

§ 371 Date: Mar. 17, 2015

(30) Foreign Application Priority Data
Sep. 17, 2012 (DE) 20 2012 103 536.7

(51) Int. Cl. G01K 1/08; G01K 13/02; G01K 1/14

(52) U.S. Cl. CPC G01K 1/08; G01K 1/14; G01K 13/02

(57) ABSTRACT

The invention relates to a high temperature sensor comprising a sensor element provided with a measuring section oriented towards the hot side, and a securing device arranged about the sensor element, said securing device comprising a securing element for securing the high temperature sensor in a receiving element, in particular a screw or a nut, and a securing strip which is arranged relative to the securing element on the hot side of the high temperature sensor and which is thermally decoupled from the securing element.

### CROSS REFERENCE TO RELATED APPLICATIONS

This application claims priority under 35 U.S.C. §119 to PCT Application Number PCT/EP2013/069157 filed Sep. 16, 2013 and which claims priority to German patent document 20 2012 103 536.7, the entire contents of which are hereby incorporated by reference herein.

### BACKGROUND

WO 2010/063682 A1 discloses a temperature sensor having a thermocouple, which includes a sheathed fireproof cable including a sensor element attached to the cable end facing the sample medium. Electric connecting leads run through a metal tube of the sheathed cable for connecting the sensor element to an electronic evaluation unit. The disclosed temperature sensor is to be usable for temperatures up to 1200° C., and capable of sensing fast temperature changes. To this end, the sensor element consists of a thermo wire bead which protrudes from the sheathed cable and is received by a protective envelope that is attached to the end of the sheathed cable facing the sample medium. The protective envelope comprises a one-piece front part, without any welding points, and the sheathed cable is a flexible thin-walled metal tube with a small outer diameter, with the connecting leads running through the section thereof pointing away from the sample medium and creating the desired interface with an on-board electronic system. The attachment of the temperature sensor to the measuring point is realized by a special ring collar and a union nut.

A high-temperature sensor having a sensor element mounted in a protective tube is disclosed in EP 2 196 787 A2. To allow reliable measurements also in high-temperature environments, e.g. the exhaust gas system of a motor vehicle, the protective tube is surrounded by a reinforcement tube, the reinforcement tube is composed of material whose coefficient of thermal expansion is higher than that of the material from which the protective tube is formed. The reinforcement tube is fixedly connected to the protective tube in a first region of the protective tube, and an abutment element is also fixedly connected to the protective tube in a second region of the protective tube. The reinforcement tube, owing to its greater thermal expansion, comes into mechanical contact with the abutment element above a predefined temperature, whereby the high-temperature sensor is mechanically stabilized above this temperature. The space between the sensor element and the protective tube cap of EP 2 196 787 A2 is filled with a material having good heat-conducting properties. In this case, fine silicon powder may be used. The stabilizing mechanical contacting of the protective tube with the abutment element requires a minimum temperature, so that particularly directly in the starting phase, respectively, the non-high-performance operation the overall arrangement tends to vibrate which may put the reliability of the measuring arrangement at risk. The high-temperature sensor can be fixed in the exhaust gas system by means of a mounting pod 4.

The high-temperature sensor may be received, for instance, on the manifold or on the welding socket of the exhaust gas system of a motor vehicle.

### SUMMARY

The present invention relates to a high-temperature sensor comprising a sensor element with a measuring section oriented to the hot side and a fixing device arranged around the sensor element.

Experiments have shown that high-temperature sensors may be subjected to an undesired transfer of heat at the measuring section to the receiving element of the high-temperature sensor. Also, the low temperature of the attachment may result in a reduction of the temperature at the measuring section, and thus in a wrong measurement result on account of this heat sink.

In addition, it may be problematical that the high temperature at the measuring section is transferred to the attachment, thus leading to an undesired temperature rise in a region that is not designed for such high temperatures. In particular, an undesired material deformation and instability of the assembly formed of high-temperature sensor and attachment may ensue.

A high-temperature sensor for temperatures greater than 500° C. allows one or more of the aforementioned problems to be avoided or the effects thereof to be reduced.

In particular, the fixing device comprises: a fixing element for fixing the high-temperature sensor in a receiving element, in particular a screw or a nut, and a fixing collar which faces the hot side relative to the fixing element and which is thermally decoupled relative to the fixing element.

The fixing collar may be designed as a flange or thrust collar. The fixing collar may also be designed as a thermal shield resulting in a shielding of the fixing element from thermal loads.

Also, it is possible to arrange additional radiation-shielding elements on the fixing collar or on the fixing element so as to protect electronic units or connection parts provided downstream thereof against thermal impact.

A protective envelope may be provided between the fixing device and the sensor element, which stabilizes the sensor element and protects it against mechanical loads.

It may be provided that the fixing collar is adjacent to the protective envelope, respectively, sensor element. The fixing element may, in comparison, be configured such that it is not adjacent to the sensor element, respectively, protective envelope thereof, and is stabilized only by the fixing collar. Thus, a further thermal decoupling can be achieved between the warming up sensor element and the fixing element, respectively, the receiving element of the high-temperature sensor.

In other embodiments, the fixing element may be supported and/or stabilized relative to the sensor element by another element, e.g. a stabilizing sleeve.

The fixing collar may immovably be connected to the sensor element, e.g. by welding to the protective envelope mounted between the sensor element and the fixing device.

In an embodiment of the invention it is provided that the thermal resistance between the fixing element and the fixing collar is more than 100 K/W, in particular more than 1000 K/W.

In an embodiment of the invention it is provided that the fixing element and the fixing collar bear against each other, wherein the bearing surface is reduced to a minimum, in particular less than 10%, preferably less than 2% of the maximum cross-sectional area of the fixing element.

The maximum cross-sectional area may, in this case, be defined as the maximum area of the fixing element in a plane which is orthogonal to the axis of the sensor element around which the fixing element is arranged.

Due to a small bearing surface between the fixing element and the fixing collar a thermal decoupling is obtained, i.e. a very low thermal conductivity. Thus, it is possible to achieve the advantages according to the invention without requiring a special thermal decoupling element between the fixing collar and the fixing element.

In an embodiment of the invention it is provided that the fixing collar is fixed to the sensor element.

In another embodiment of the invention it is provided that a decoupling element of a material having a low thermal conductivity is arranged between the fixing element and the fixing collar, in particular a thermal conductivity of less than 20 W/mK at 1000° C., preferably less than 5 W/mK at 1000° C.

A decoupling element between the fixing collar and the fixing element allows a particularly good thermal decoupling to be obtained.

In another embodiment of the invention it is provided that the decoupling element is made of ceramic.

In another embodiment of the invention it is provided that the decoupling element is disc-shaped, in particular that the decoupling element is a washer.

In another embodiment of the invention it is provided that the decoupling element is a pressure screw or a union nut.

A disc-shaped decoupling element allows to achieve a particularly good thermal decoupling along with a sufficient mechanical stability between the fixing collar and the fixing element.

The decoupling element may be fixed between the fixing collar and the fixing element, e.g. by welding, or, if a washer is used, it may be arranged removably between the fixing collar and the fixing element.

In another embodiment of the invention it is provided that the high-temperature sensor comprises a protective envelope which surrounds the sensor element at least partially.

Also, it may be provided that a stabilizing and fixing sleeve is arranged around the control element and/or around the protective envelope, and is fixed, in particular welded to the fixing element.

By this, the stabilizing and fixing sleeve profits from the thermal decoupling of the control element. The stabilizing and fixing sleeve is thus exposed to lower temperature loads and may be manufactured from materials that have a lower temperature stability.

In other embodiments it may be provided that the stabilizing and fixing sleeve is fixed to the fixing collar and/or to the bearing surface between the fixing collar and the fixing element, e.g. by welding. Although the stabilizing and fixing sleeve does thus not profit from the thermal decoupling to the same extent, a higher mechanical stability may be obtained.

According to another aspect of the invention a high-temperature sensor comprising a fixing element for fixing it to a receiving element is provided, wherein the fixing element includes a recess for an exact, predefinable positional orientation. Thus, it is possible to ensure the correct position of the high-temperature sensor, e.g. in case that the sensor element and/or the protective envelope around the sensor element are not configured rotationally symmetrical, but have a preferred orientation.

In particular, the recess may be a shaped portion in a circular configuration of the fixing element.

The high-temperature sensor will be explained in more detail below by means of exemplary embodiments and with the aid of figures.

### BRIEF DESCRIPTION OF THE DRAWINGS

In the drawings:

FIG. 1a shows a first longitudinal view of a high-temperature sensor;

FIG. 1b shows a second longitudinal view of the high-temperature sensor of FIG. 1;

FIG. 2a shows a front view of the high-temperature sensor of FIG. 1 from the hot side of the sensor;

FIG. 2b shows a rear view of the high-temperature sensor of FIG. 1 from the cold side of the sensor;

FIG. 3a shows a lateral view of another high-temperature sensor;

FIG. 3b shows a longitudinal view of the high-temperature sensor of FIG. 3a;

FIG. 3c shows a top view of the high-temperature sensor of FIG. 3a;

FIG. 3d shows a cross-sectional view of the high-temperature sensor of FIG. 3a, and

FIG. 3e shows a perspective view of the high-temperature sensor of FIG. 3a.

### DETAILED DESCRIPTION

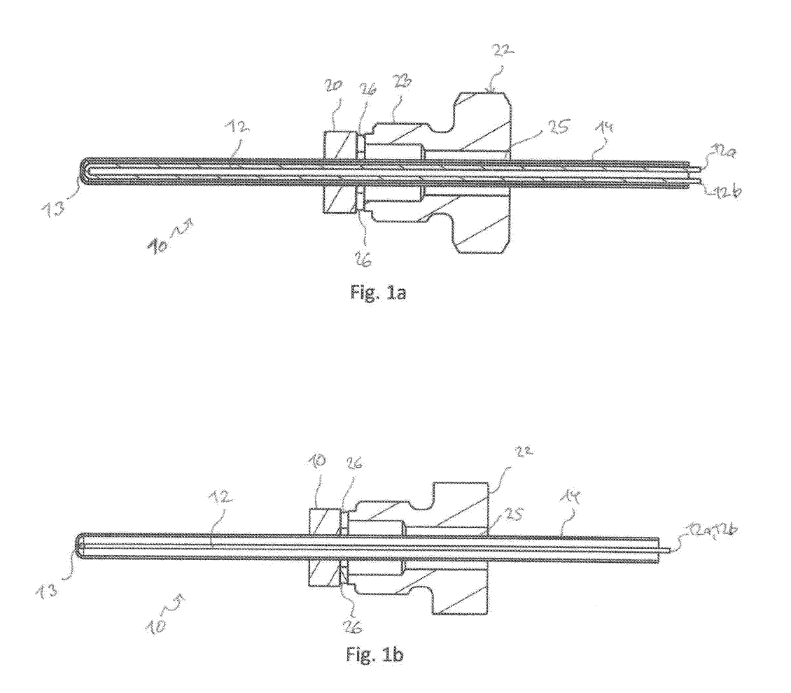

FIG. 1a shows a high-temperature sensor 10 with a fixing device comprising a fixing collar 20 and a fixing element 22. The fixing element 22 is designed as a screw 22 with an external thread 23. The screw 22 has a hollow space 25 so that the sensor element 12 including the protective envelope 14 arranged around same can be passed through the screw 22.

The sensor element 12 includes a measuring section 13 on the hot side. Electrical connections 12a, 12b are located on the cold side. The sensor element 12 is formed substantially of two parallel rods and the measuring section 13 arranged at the hot end of these rods.

For instance, in the center of the high-temperature sensor 10 the fixing collar 20 and the fixing element 22 are arranged around the sensor element 12 and the protective envelope 14. The fixing collar 20 is here welded to the protective envelope 14.

A decoupling element 26 is arranged between the fixing collar 20 and the screw 22. The decoupling element 26 is configured, for instance, as a ceramic ring and acts as a thermal barrier, meaning it allows an effective thermal decoupling between the fixing collar 20 and the screw 22.

FIG. 1b shows a second longitudinal view of the high-temperature sensor of FIG. 1. The cutting plane is, in this case, orthogonal to the cutting plane shown in FIG. 1a. The two connection elements are, therefore, not individually visible in FIG. 1b.

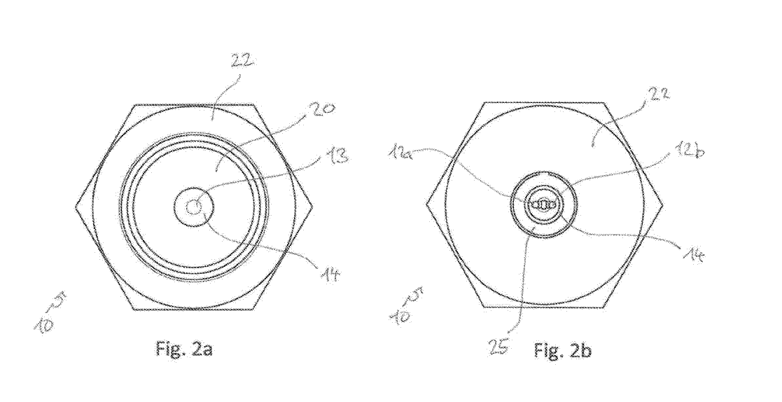

FIG. 2a shows a top view from the hot side of the high-temperature sensor 10 of FIG. 1. The measuring section 13 is visible in the center, surrounded by the protective envelope 14. Further to the outside the fixing collar 20 and the screw 22 having a hexagon head are visible.

FIG. 2b shows a top view from the cold side of the high-temperature sensor 10 of FIG. 1.

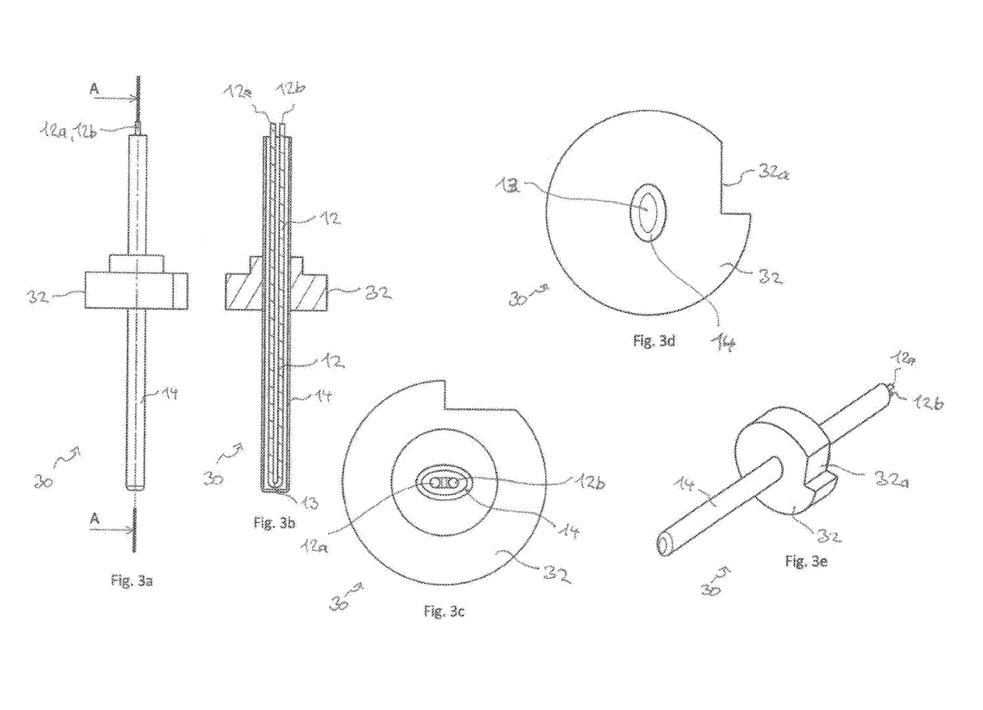

FIGS. 3a to 3e show another high-temperature sensor 30 according to a further aspect of the present invention. The high-temperature sensor 30 comprises, in this case, an ellipsoidal, i.e. not rotationally symmetrical sheath thermocouple which comprises an ellipsoidal protective envelope 14 and a likewise ellipsoidal sensor element 12.

The high-temperature sensor 30 is fixed to a receiving element by the fixing element 32. Preferably, the fixing is to be accomplished such that the longer axis of the ellipse shape of the protective envelope 14, respectively, the sensor element 12 is oriented along the flow direction of the medium to be measured. Such a positioning is permitted by the recess 32a which is adjacent to a corresponding counterpart in a receiving element for the high-temperature sensor 30.

FIG. 3b shows a longitudinal section through the longer axis of the ellipse shape. In the plane of projection, respectively, parallel thereto the medium to be measured flows around the sheath thermocouple 12, 14.

In the top view 3c from the cold side the electrical connections as well as the double-circle configuration and the recess for the positional orientation are visible.

In the perspective view according to FIG. 3e the high-temperature sensor 30 is shown from the hot side. Again, the angular recess 32a is visible.

1. A high-temperature sensor (10) comprising:
a sensor element (12) with a measuring section oriented to a hot side (10a), and
a fixing device arranged around the sensor element (12), characterized in that the fixing device comprises:
a fixing element (22) for fixing the high-temperature sensor (10) in a receiving element, and
a fixing collar (20) which is arranged relative to the fixing element (22) on the hot side of the high-temperature sensor (10) and which is thermally decoupled relative to the fixing element (22).

2. The high-temperature sensor according to claim 1, characterized in that the thermal resistance between the fixing element (22) and the fixing collar (20) is more than 100 K/W.

3. The high-temperature sensor according to claim 1, characterized in that the fixing element (22) and the fixing collar (20) bear against each other, wherein the bearing surface is less than 10%, of the maximum cross-sectional area of the fixing element (22).

4. The high-temperature sensor according to claim 1, characterized in that the fixing collar (20) is fixed to the sensor element (12).

5. The high-temperature sensor according to claim 1, characterized in that a decoupling element (26) having a low thermal conductivity coefficient is arranged between the fixing element (22) and the fixing collar (20), and wherein the thermal conductivity coefficient of the decoupling element (26) is less than 20 W/mK at 1000° C.

6. The high-temperature sensor according to claim 5, characterized in that the decoupling element (26) is made of ceramic.

7. The high-temperature sensor according to claim 5, characterized in that the decoupling element (26) is disc-shaped.

8. The high-temperature sensor according to claim 5, characterized in that the decoupling element (26) is a pressure screw or a union nut.

9. The high-temperature sensor according to claim 1, characterized in that the high-temperature sensor (10) comprises a protective envelope (14) which surrounds the sensor element (12) at least partially.

10. The high-temperature sensor according to claim 1, characterized in that a stabilizing and fixing sleeve is arranged around the sensor element (12) and/or around the protective envelope (14), and is fixed to the fixing element.

11. The high-temperature sensor according to claim 1, characterized in that the thermal resistance between the fixing element (22) and the fixing collar (20) is more than 1000 K/W.

12. The high-temperature sensor according to claim 1, characterized in that the fixing element (22) and the fixing collar (20) bear against each other, wherein the bearing surface is less than 2% of the maximum cross-sectional area of the fixing element (22).

13. The high-temperature sensor according to claim 1, characterized in that a decoupling element (26) having a low thermal conductivity coefficient is arranged between the fixing element (22) and the fixing collar (20), and wherein the thermal conductivity coefficeint of the decoupling element (26) is less than 5 W/mK at 1000° C.

14. The high-temperature sensor according to claim 2, characterized in that a decoupling element (26) having a low thermal conductivity coefficient is arranged between the fixing element (22) and the fixing collar (20), and wherein the thermal conductivity coefficient of the decoupling element (26) is less than 20 W/mK at 1000° C.

15. The high-temperature sensor according to claim 3, characterized in that a decoupling element (26) having a low thermal conductivity coefficient is arranged between the fixing element (22) and the fixing collar (20), and wherein the thermal conductivity coefficient of the decoupling element (26) is less than 20 W/mK at 1000° C.

16. The high-temperature sensor according to claim 4, characterized in that a decoupling element (26) having a low thermal conductivity coefficient is arranged between the fixing element (22) and the fixing collar (20), and wherein the thermal conductivity coefficient of the decoupling element (26) is less than 20 W/mK at 1000° C.

17. The high-temperature sensor according to claim 2, characterized in that the high-temperature sensor (10) comprises a protective envelope (14) which surrounds the sensor element (12) at least partially.

18. The high-temperature sensor according to claim 3, characterized in that the high-temperature sensor (10) comprises a protective envelope (14) which surrounds the sensor element (12) at least partially.

19. The high-temperature sensor according to claim 2, characterized in that a stabilizing and fixing sleeve is arranged around the sensor element (12) and/or around the protective envelope (14), and is fixed to the fixing element.

20. The high-temperature sensor according to claim 3, characterized in that a stabilizing and fixing sleeve is arranged around the sensor element (12) and/or around the protective envelope (14), and is fixed to the fixing element.
